(19) United States
(12) Patent Application Publication
(10) Pub. No.: US 2006/0065587 A1
(43) Pub. Date: Mar. 30, 2006

(54) Porous membrane cartridge and method of manufacturing the same

(75) Inventors: Keiji Shigesada, Kanagawa (JP); Morio Fujiwara, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/226,322

(22) Filed: Sep. 15, 2005

(30) Foreign Application Priority Data
Sep. 27, 2004 (JP) 2004-280250

(51) Int. Cl. B01D 63/00

(52) U.S. Cl. 210/321.87; 210/497.01; 210/500.29; 210/500.3

(57) ABSTRACT

Porous membrane cartridge includes: a tubular-shaped barrel member having a weld portion at an outer peripheral surface positioned adjacent to one end thereof; a tubular-shaped cap member having a weld portion, inner peripheral surface of which contacts the weld portion of the barrel member, and a sandwiching surface which faces to an open edge portion of the barrel member-side weld portion; and a porous membrane sandwiched between the open edge portion of the barrel member-side weld portion and the sandwiching surface of the cap member. Porous membrane cartridge is manufactured by inserting the cap member and the porous membrane in a cavity of a mold for injection molding, and thereafter injecting molding material into the cavity to form the barrel member. Cap member-side weld portion has a ratio of its height (H) and its diameter (D), which is defined by H/D, to be equal to or greater than 0.07.

### CROSS REFERENCE TO RELATED APPLICATIONS

This application claims the foreign priority benefit under Title 35, United States Code, §119(a)-(d) of Japanese Patent Application No. 2004-280250, filed on Sep. 27, 2004 in the Japan Patent Office, the disclosure of which is herein incorporated by reference in its entirety.

### BACKGROUND OF THE INVENTION

The present invnetion relates to a porous membrane cartridge and a method of manufacturing the porous membrane cartridge. The porous membrane cartridge is used for filtering liquid and the like and is manufacutured by insert injection molding.

Porous membrane is widely used in laboratories or factories for filtering liquid or for separating/refining a particular substance within a liquid. When the porous membrane is used for this purpose, it has to be retained at an intermediate of the passage where the liquid flows in. In general, the porous membrane is sandwiched and retained between two members each having a passage through which liquid can flow.

Such a porous membrane is generally used for experiments and measurements requiring accuracy, and thus requires cleanliness. Once the porous membrane is used, it is usually replaced with another one. For this reason, taking into consideration the cleanliness and convenience for use, it is advantageous that the porous membrane is manufactured as a cartridge in which the porous membrane is retained to allow liquid to flow through the membrane. For example, Japanese Laid-open Patent Application No. 2003-128691 (see paragraphs [0032] to [0046] and FIG. 2) discloses such a porous membrane cartridge as a nucleic acid separating/refining unit.

As shown in FIG. 2 of Japanese Laid-open Patent Application No. 2003-128691, the nucleic acid separating/refining unit includes a main body, a cap, and a solid phase (porous membrane) sandwiched and retained between the main body and the cap. The main body and the cap are joined by a known joint method, such as ultrasonic welding, heat welding using laser, and other joint methods using adhesive and/or screws.

Upon manufacturing this nucleic acid separating/refining unit, two molded pieces (the main body and the cap) are joined, for example, by ultrasonic welding after they are assembled together. Therefore, dedicated equipment such as an ultrasonic welding machine is required, leading to increased equipment cost. Further, upon manufacturing a nucleic acid separating/refining unit where a large number of the units are joined together, a large number of molded pieces are pressed simultaneously to sandwich solid phases (porous membranes). Because molded pieces usually have different heights due to manufacturing error, pressing the large number of molded pieces causes a difference in applied forces for pressing the solid phases, thereby causing defective sealing of the solid phase or breakage due to too much pressing of the solid phases.

In the porous membrane cartridge of which porous membrane is used for filtering liquid or separating/refining a particular substance within a liquid, it is necessary to introduce the liquid under pressure by means of a pump, gravity or compressed gas to pass the liquid through the porous membrane. During this time, gaps are likely to appear in the conventional porous membrane cartridge at a joint surface or a fusion surface between molded pieces, because the bond strength between the molded pieces lowers. This allows the liquid that is to flow through the porous membrane to flow aside toward the side portion of the porous membrane. Especially, when the porous membrane cartridge is used for separating/refining nucleic acids, nucleic acids are adsorbed from blood, cells or the like by the porous membrane, followed by desorption (collection) of the nucleic acids at a post-process by introducing a particular liquid. If the liquid flows aside toward the side portion of the porous membrane, loss of nucleic acids results and a further disadvantage arises such that impurities are mixed with the desorbed nucleic acids during the post-process.

With the foregoing drawbacks of the conventional porous membrane cartridge in view, the present invention seeks to provide a porous membrane cartridge which prevents the liquid from flowing aside toward the side portion of the porous membrane.

### SUMMARY OF THE INVENTION

It is an aspect of the present invention to provide a porous membrane cartridge, which includes: a tubular-shaped barrel member having a weld portion at an outer peripheral surface positioned adjacent to one end thereof; a tubular-shaped cap member having a weld portion, inner peripheral surface of which contacts the weld portion of the barrel member, and a sandwiching surface which faces to an open edge portion of the weld portion of the barrel member; and a porous membrane sandwiched between the open edge portion of the weld portion of the barrel member and the sandwiching surface of the cap member. The porous membrane cartridge is manufactured by inserting the cap member and the porous membrane in a cavity of a mold for injection molding, and thereafter injecting molding material into the cavity to form the barrel member. The weld portion of the cap member has a ratio of its height (H) and its diameter (D), which is defined by H/D, to be equal to or greater than 0.07.

According to this porous membrane cartridge, since the inner peripheral surface of the weld portion of the cap member has an area within a predetermined range, the bond strength increases at the weld surface between the cap member and the barrel member, that is, at the inner peripheral surface of the weld portion of the cap member and the outer peripheral surface of the weld portion of the barrel member, avoiding gaps generated at the weld surface. Therefore, even if liquid is introduced into the porous membrane cartridge under pressure, it is possible to prevent the liquid from flowing aside toward the side portion of the porous membrane. For this reason, when the porous membrane cartridge is used for filtration or separation/refinement, it is possible to prevent a loss of liquid due to the liquid flowing aside toward the side portion of the porous membrane and pollution by the discharged liquid.

According to the aforementioned porous membrane cartridge, the weld portion of the cap member may be formed such that a maximum surface roughness of the inner peripheral surface is greater than 5 μm. With this construction of the porous membrane cartridge, the weld portion of the cap member generates, at the inner peripheral surface, an anchoring force (anchoring effect) relative to the weld portion of the barrel member, which further increases the bond strength at the weld surface between the cap member and the barrel member.

According to the aforementioned porous membrane cartridge, the weld portion of the cap member may have an undercut shape at the inner peripheral surface. With this construction of the porous membrane cartridge, the weld portion of the cap member generates, at the inner peripheral surface, an anchoring force (anchoring effect) relative to the weld portion of the barrel member, which further increases the bond strength at the weld surface between the cap member and the barrel member.

According to the aforementioned porous membrane cartridge, the porous membrane may be a nucleic acid adsorptive porous membrane. With this construction of the porous membrane cartridge, it is possible to prevent a loss of nucleic acids due to the nucleic acids flowing aside toward the side portion of the porous membrane and pollution by the discharged (collected) nucleic acids.

According to the aforementioned porous membrane cartridge, the barrel member may be molded within one hour after molding the cap member. With this construction of the porous membrane cartridge, the cap member shrinks after the insertion of the cap member in the cavity of the mold for injection molding, which further increases the bond strength at the weld surface between the cap member and the barrel member.

Further, according to the aforementioned porous membrane cartridge, the ratio of H/D may be equal to or smaller than 1.3.

Further, according to the aforementioned porous membrane cartridge, the weld portion of the cap member may be subject to surface texturing at the inner peripheral surface. Alternatively, the weld portion of the cap member may be subject to surface etching at the inner peripheral surface.

According to the aforementioned porous membrane cartridge, the porous membrane may comprise a surface saponified material of acetyl cellulose.

It is another aspect of the present invention to provide a method of manufacturing a porous membrane cartridge including the steps of: providing an injection mold having a cavity which corresponds to a tubular-shaped barrel member having a weld portion at an outer peripheral surface positioned adjacent to one end of the barrel member; molding a tubular cap member having a weld portion and a sandwiching surface facing to an open edge portion of the weld portion of the barrel member, wherein the weld portion of the cap member contacts the weld portion of the barrel member at its inner surface and a ratio of its height (H) and its diameter (D), defined by H/D, is equal to or greater than 0.07; positioning the cap member and the porous membrane within the cavity such that the weld portion of the cap member contacts the weld portion of the barrel member at its inner surface while positioning the sandwiching surface of the cap member in a manner facing to the open edge portion of the weld portion of the barrel member and setting the porous membrane with its peripheral edge abutting on the sandwiching surface of the cap member; and injecting molding material into the cavity.

According to the method of manufacturing a porous membrane cartridge according to the present invention, it is possible to prevent the liquid from flowing aside toward the side portion of the porous membrane.

According to the aforementioned manufacturing method, the molding material may be injected within one hour after molding the cap member.

According to the aforementioned manufacturing method, the step of molding the cap member may include providing the inner peripheral surface of the weld portion of the cap member with an undercut shape.

According to the aforementioned manufacturing method, the step of molding the cap member may include applying a surface treatment to the weld portion of the cap member at the inner peripheral surface.

Further, according to the aforementioned manufacturing method, the step of molding the cap member may include processing the weld portion of the cap member such that a maximum surface roughness of the inner peripheral surface becomes greater than 5 μm.

Further, according to the aforementioned manufacturing method, the porous membrane may be a nucleic acid adsorptive porous membrane.

Other features and advantages of the present invention will be apparent from the following description.

### BRIEF DESCRIPTION OF THE DRAWINGS

The aspects of the present invention will become more apparent by describing in detail illustrative, non-limiting embodiments thereof with reference to the accompanying drawings, in which:

FIG. 1 is an exploded perspective view of a porous membrane cartridge according to one exemplary embodiment of the present invention;

FIG. 2 is an enlarged sectional perspective view of an insert shown in FIG. 1;

FIG. 3A is a sectional view of an injection mold for molding the porous membrane cartridge wherein a cap member is inserted into the injection mold, and FIG. 3B is a sectional view of the injection mold wherein the injection mold is closed;

FIG. 4A is a sectional view of the injection mold for molding the porous membrane cartridge wherein resin is injected into the injection mold, and FIG. 4B is a sectional view of the injection mold wherein the injection of resin is completed;

FIG. 5A is an enlarged sectional view of the part A shown in FIG. 4B after the resin injection is completed, and FIG. 5B shows a modified embodiment of FIG. 5A; and

FIG. 6 is a sectional view illustrating a manner of use of the porous membrane cartridge.

### DETAILED DESCRIPTION OF THE INVENTION

With reference to the accompanying drawings, preferred embodiments of the present invention will be described below.

Structure of Porous Membrane Cartridge

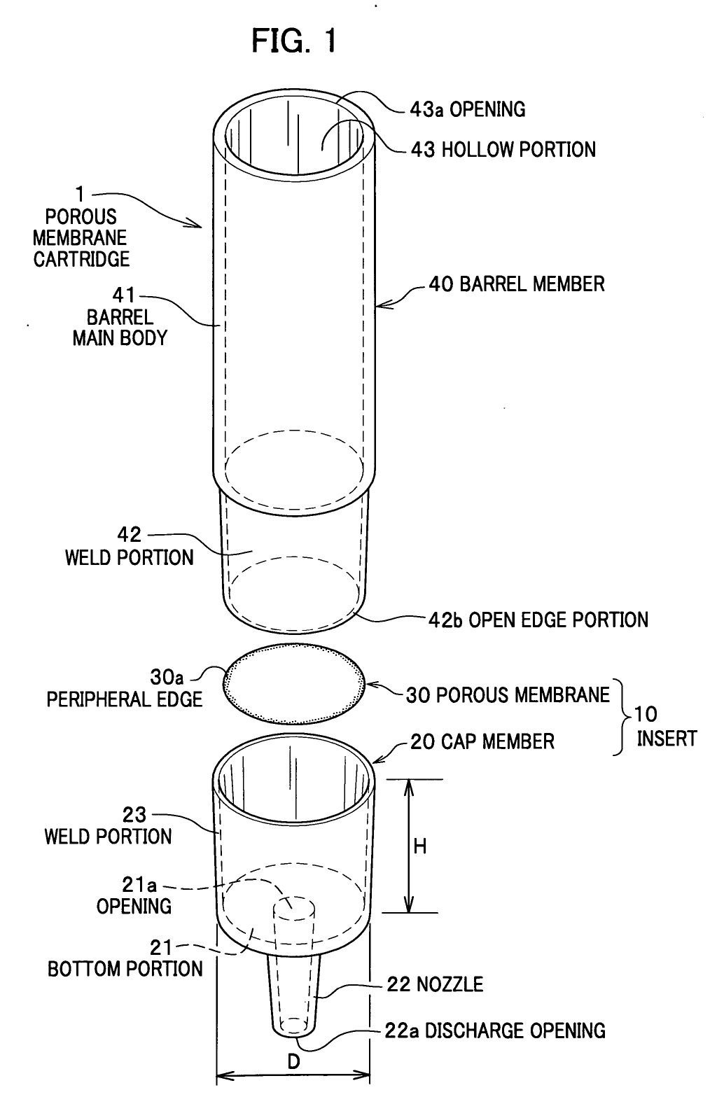

As shown in FIG. 1, a porous membrane cartridge 1 according to this embodiment includes an insert 10 consisting of a cap member 20 and a porous membrane 30, and a barrel member 40 formed by insertion injection molding with the insert 10 placed in a mold cavity.

The barrel member 40 of the porous membrane cartridge 1 is formed integrally with the cap member 20 and the porous membrane 30 by insertion injection molding. However, FIG. 1 illustrates the barrel member 40 as a separate member for the purpose of explanation.

Insert 10

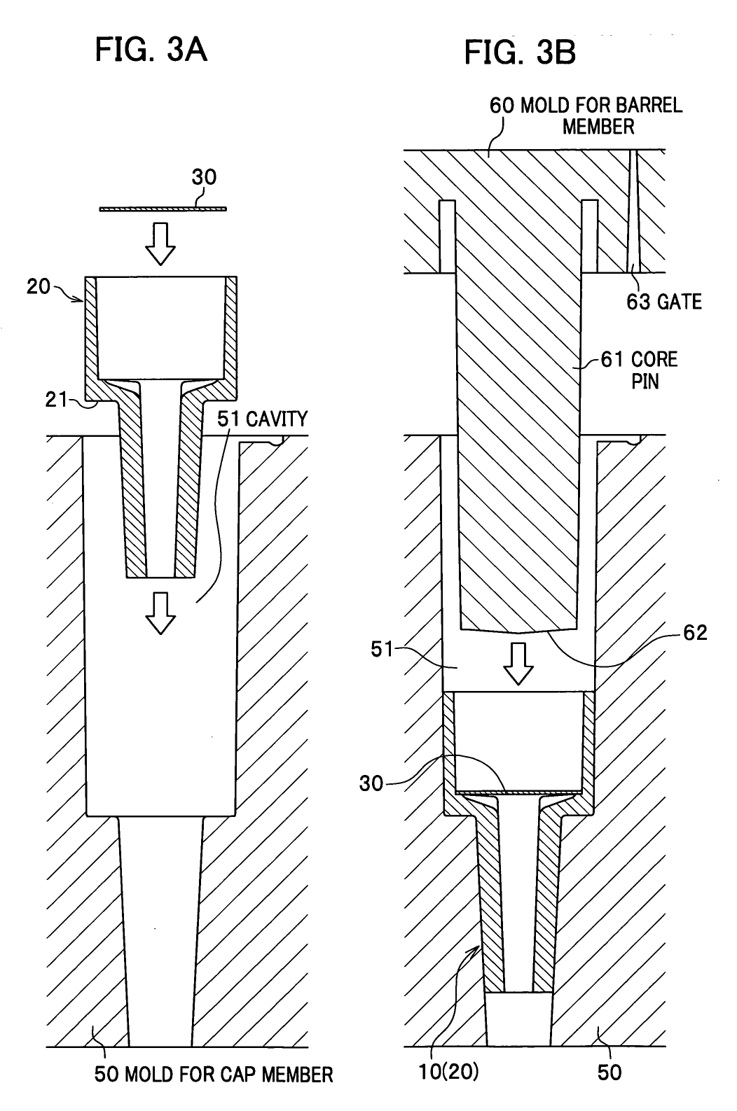

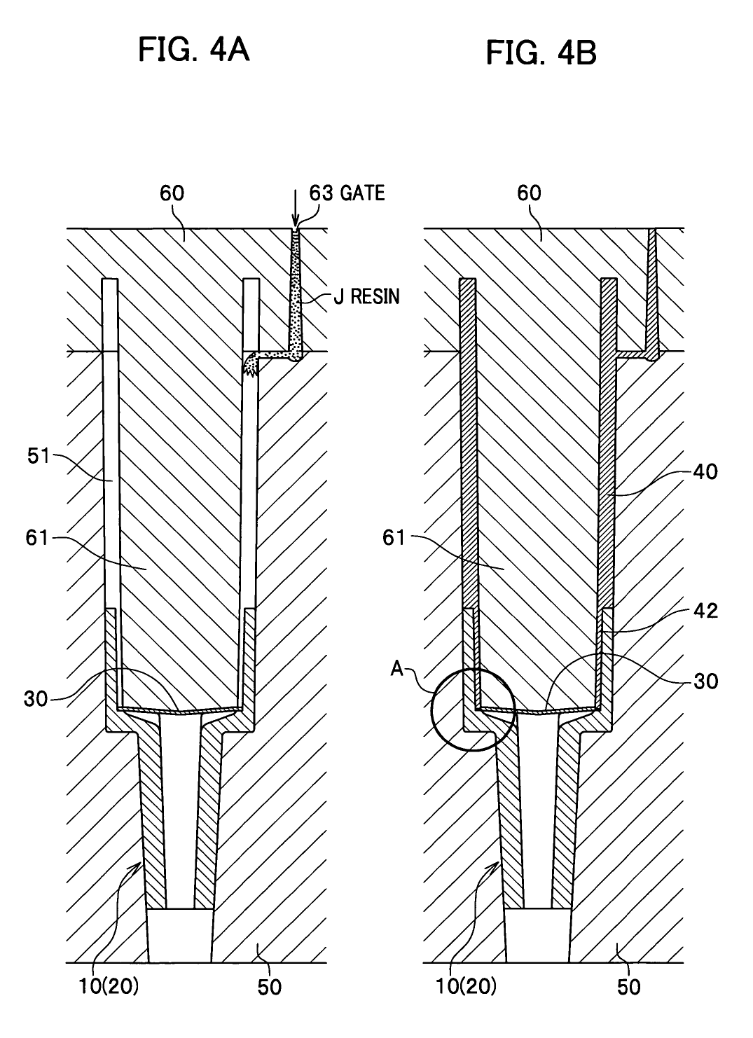

The insert 10 consists of the cap member 20 and the porous membrane 30 for adsorbing and collecting nucleic acids or the like by filtering or separating/refining a liquid. As shown in FIGS. 3A and 3B, the insert 10 is set in advance within an injection mold (cap member-side mold 50 and barrel member-side mold 60) for molding the porous membrane cartridge 1, followed by injection of molten resin J into a cavity 51 so that the insert 10 is welded to the barrel member 40 that is molded by the resin J (FIGS. 4A and 4B). The resin J corresponds to molding material defined in the claims.

Cap member 20

The cap member 20 consists of a bottom portion 21 having an opening 21a at its center, a nozzle (discharge portion) 22 extending downward from the bottom surface of the bottom portion 21, a weld portion (cap member-side weld portion) 23 extending in the opposite direction of the nozzle 22 along the outer periphery of the bottom portion 21 to have a tubular profile. Provided at the tip end of the nozzle 22 is a discharge opening 22a which is in communication with the opening 21a of the bottom portion 21. The weld portion 23 is welded to a weld portion 42 of the barrel member 40 to be described later with the inner surface of the weld portion 23 contacting with the outer surface of the weld portion 42. The inner diameter of the weld portion 23 is substantially the same as the diameter of the porous membrane 30.

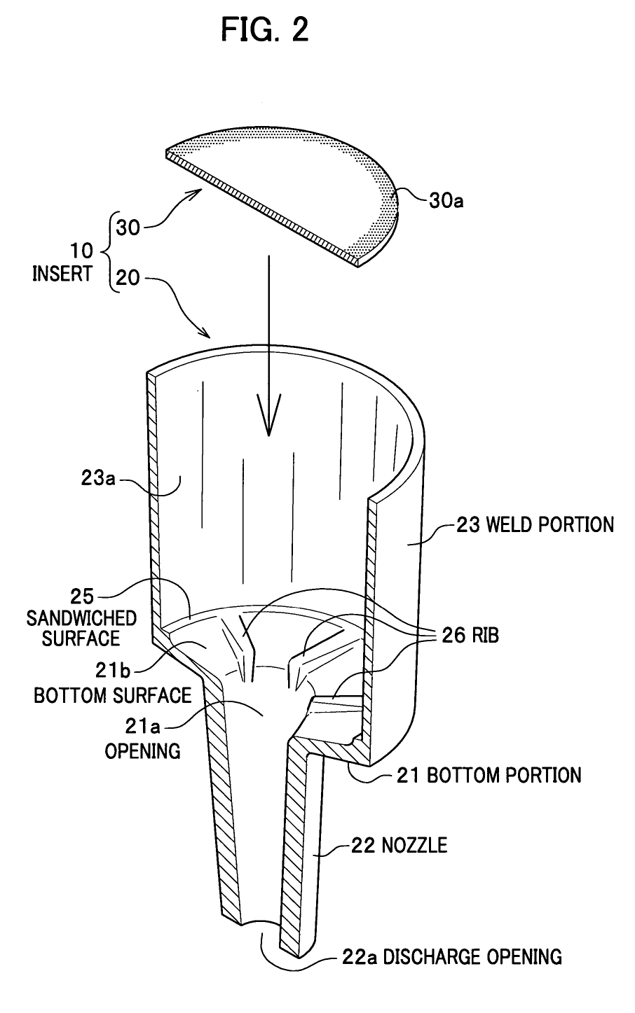

As shown in FIG. 2, the bottom portion 21 of the cap member 20 is constructed such that an annular-shaped sandwiching surface 25 is formed along the outer periphery of the bottom surface 21b. The sandwiching surface 25 is one step higher than the bottom surface 21b. The sandwiching surface 25 is a planar surface which contacts the peripheral edge 30a of the porous membrane 30 to be described later. To ease a discharge of liquid, the bottom surface 21b tilts from the sandwiching surface 25 to the opening 21a such that the closer it becomes to the opening 21a (discharge opening 22a) the lower it becomes. Further, six ribs 26 are radially arranged at the bottom surface 21b although only three of them are illustrated in FIG. 2. The ribs 26 protrude from the bottom surface 21b and tilt against the horizontal plane at an angle smaller than the tilt angle of the bottom surface 21b such that the closer they become from the sandwiching surface 25 to the opening 21a the lower they become.

As shown in FIG. 1, the weld portion 23 is formed such that a ratio of its height (H) and its diameter (D: outer diameter of the bottom portion 21), defined by H/D, is preferably equal to or greater than 0.07. More preferably, the ratio H/D is equal to or greater than 0.10, and most preferably the ratio is equal to or greater than 0.20. If the ratio H/D is over the above value, the bond strength at the weld surface between the weld portions 23 and 42 increases and it is possible to further prevent liquid from flowing aside toward the side portion of the porous membrane 30.

The upper limit of the ratio H/D is preferably 1.3. If the ratio H/D becomes greater than 1.3, the distance (height) of a small space, which is formed between a core pin 61 and the cap member 20 (cap member-side weld portion 23) and into which injected resin flows during the insertion injection molding process for forming the barrel member 40 to be described later, becomes longer. Therefore, resin J to be injected in the cavity solidifies before reaching the bottom end of the small space, leading to defectiveness of the barrel member 40. Due to solidification of resin J before reaching the bottom end of the small space, the resin J does not readily flow into fine asperities on the inner peripheral surface 23a of the cap member-side weld portion 23, which form a phase boundary between the cap member 20 and the barrel member 40, as illustrated in FIG. 4B. As a result, the bond strength at the weld surface between the cap member 20 and the barrel member 40 decreases, and liquid is likely to flow aside toward the side portion of the porous membrane 30. However, solidification of the resin J and the flow of the resin J into the phase boundary vary in accordance with molding temperature, property of the resin J, etc., and therefore, the upper limit of the ratio H/D is not limited to 1.3.

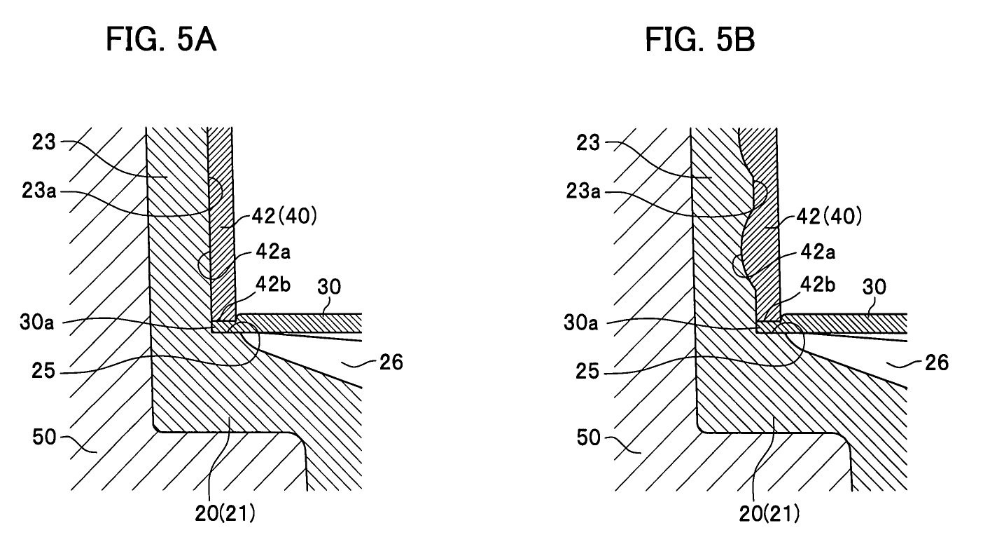

The weld portion 23 of the cap member 20 is formed such that the maximum surface roughness (average maximum height of the profile; Rz) of the inner peripheral surface 23a (see FIG. 2) is preferably greater than 5 μm, and more preferably equal to or greater than 10 μm. If the maximum surface roughness is set to be more than the above value, a sufficient anchoring force (anchoring effect) can be obtained at the weld surface between the weld portion 23 of the cap member 20 and the weld portion 42 of the barrel member 40, that is, between the inner peripheral surface 23a of the weld portion 23 and the outer peripheral surface 42a of the weld portion 42 (FIG. 5A). Therefore, the bond strength at the weld surface is increased, and it is possible to further prevent liquid from flowing aside toward the side portion of the porous membrane 30.

As shown in FIG. 5B, the weld portion 23 of the cap member 20 preferably has an undercut shape at its inner peripheral surface 23a. To provide the undercut shape allows the inner peripheral surface 23a of the weld portion 23 and the outer peripheral surface 42a of the weld portion 42 (FIG. 5B) to have a sufficient anchoring effect. Therefore, the bond strength at the weld surface can be increased, and it is possible to further prevent liquid from flowing aside toward the side portion of the porous membrane 30. The undercut shape of the cap member 20 can be obtained in such a manner that a particular shape for providing the undercut shape is given to the mold for the cap member 20. Alternatively or additionally to provide an undercut shape, it is possible to give a surface modification, such as texturing and etching, to the inner peripheral surface 23a of the weld portion 23.

As a material to mold the cap member 20, various resins suitable for insertion injection molding can be used, such as polypropylene, polystyrene, polycarbonate, and polyvinyl chloride. Further, biodegradable material, such as polylactic resin, can also be used.

Porous Membrane 30

As shown in FIG. 2, the porous membrane 30 is a circular membrane, the diameter of which is substantially the same as the inner diameter of the weld portion (cap member-side weld portion) 23. The porous membrane 30 has a large number of fine pores so that nucleic acids or the like can be collected by means of filtration of a liquid or separation/refinement (adsorption of nucleic acids) of the liquid. The porous membrane 30 is placed on the sandwiching surface 25 of the cap member 20, and forms a part of the insert 10. The peripheral edge 30a of the porous membrane 30 abuts on the sandwiching surface 25 of the cap member 20, and upon injection molding the barrel member 40 to be described later, the peripheral edge 30a is pressed against the sandwiching surface 25 by the injection pressure of the resin J. The peripheral edge 30a of the porous membrane 30 is sandwiched and held between an open edge portion 42b of the weld portion 42 and the sandwiching surface 25 of the cap member 20, so that as shown in FIGS. 4A, 4B and FIGS. 5A, 5B, the peripheral edge 30a is compressed and held at the bottom portion 21 of the porous membrane cartridge 1 (cap member 20).

The porous membrane 30 is a porous membrane made of organic polymer, and its thickness is preferably in the range of 10 to 500 μm. If the porous membrane is a nucleic acid adsorptive porous membrane, for example, a porous membrane comprising a surface saponified material of acetyl cellulose is preferable. The saponification rate is preferably equal to or greater than 5%. Although acetyl cellulose may be any of monoacetyl cellulose, diacetyl cellulose, and triacetyl cellulose, triacetyl cellulose is most preferable. Preferably, the nucleic acid adsorptive porous membrane is a porous membrane having the minimum pore diameter equal to or greater than 0.22 μm, the ratio of the maximum pore diameter to the minimum pore diameter equal to or greater than 2, the porosity within a range of 50 to 95%, the bubble-point pressure within a range of 9.8 to 980 kPa (0.1 to 10 kg/cm²), the pressure loss within a range of 0.1 to 100 kPa, and the adsorption amount of nucleic acids per 1 mg of porous membrane equal to or greater than 0.1 μg. Herein, the pressure loss indicates the minimum pressure that is required for water to pass through the porous membrane in the thickness of 100 μm.

When the porous membrane 30 is used as a general filter, a porous membrane such as made of PTFE (polytetrafluoroethylene) polyamide, polypropylene, and polycarbonate may be used.

Barrel Member 40

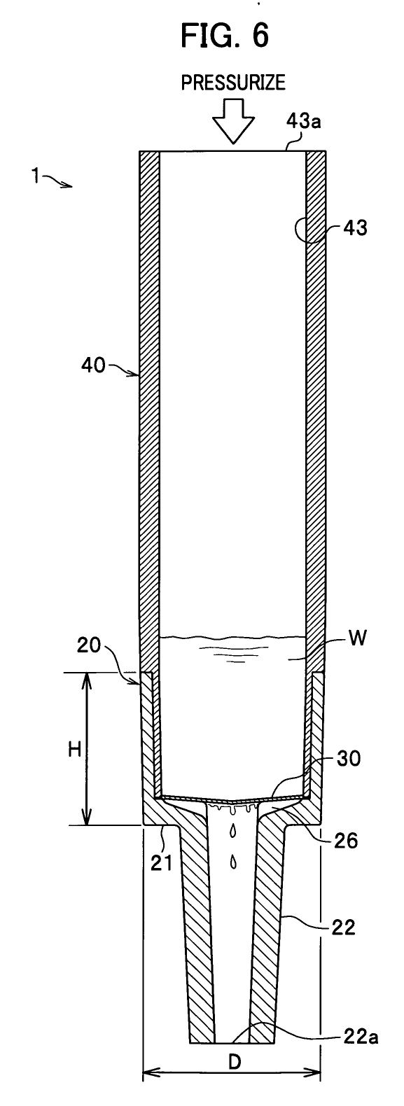

As shown in FIG. 1, the barrel member 40 has a weld portion (barrel member-side weld portion) 42 at an outer peripheral surface positioned adjacent to one end of the barrel member 40. The barrel member 40 consists of a tubular barrel main body 41, and the tubular weld portion 42 extending from the barrel main body 41. As shown in FIGS. 3A and 3B, the barrel member 40 is formed by injecting resin J into a cavity 51 of a mold 50 for the cap member 20 after the insert 10 is set within the mold 50. As best seen in FIG. 6, a hollow portion 43 of the barrel member 40 serves to temporally reserve liquid or the like. As shown in FIGS. 4A and 4B, the hollow portion 43 is formed by using a core pin 61 equipped with a mold 60 for the barrel member 40 to be described later. The upper end of the hollow portion 43 is open to provide an opening 43a, and the lower end of the hollow portion 43 is closed by the porous membrane 30. The weld portion (barrel member-side weld portion) 42 is molded by the resin J flowing into the cavity 51 (FIGS. 4A and 4B) that is formed between the core pin 61 and the cap member 20 (cap member-side weld portion 23). Therefore, the inner peripheral surface 23a of the weld portion 23 (FIG. 2) is welded by heat that is caused by the resin J flowing into the cavity 51, so that the barrel member 40 and the insert 10 become integral to each other. The terms “mold 50 for the cap member 20” and “mold 60 for the barrel member 40” correspond to the “mold for injection molding” defined in the claims.

As a material to mold the barrel member 40, various resins suitable for insertion injection molding can be used, such as polypropylene, polystyrene, polycarbonate, and polyvinyl chloride. Further, biodegradable material, such as polylactic resin, can also be used.

Manufacturing Method for Porous Membrane Cartridge

With reference to the accompanying drawings, a method of manufacturing the porous membrane cartridge will be described.

A known injection molding machine can be used for manufacturing the porous membrane cartridge 1. According to this embodiment, the injection molding machine requires setting the insert 10 within the injection mold. Therefore, it is preferable to employ a vertically-arranged type injection molding machine. However, it is possible to employ a horizontally-arranged type injection molding machine as long as the insert 10 (porous membrane 30) can be retained in a predetermined position.

Insert 10

As shown in FIG. 3A, the porous membrane 30 is placed on the bottom portion 21 of the cap member 20 to prepare the insert 10. The cap member 20 is formed in advance by molding. The insert 10 is then inserted into the cavity 51 formed in the mold 50 for the cap member 20.

The insert 10 may be prepared in advance. Preparation and insertion of the insert 10 may be made with the use of a known assembling robot.

Mold-Closing and Retention of Porous Membrane 30

As shown in FIG. 3B, after the insert 10 is set within the mold 50 for the cap member 20, the mold 60 for the barrel member 40 is assembled with the mold 50, thereby closing the mold.

The mold 60 for the barrel member 40 is equipped with the cylindrical core pin 61 in a position corresponding to the hollow portion 43 of the porous membrane cartridge 1. When the molds 50, 60 are closed, the distal end 62 of the core pin 61 abuts on the upper surface of the porous membrane 30 to sandwich the porous membrane 30 against the sandwiching surface 25 of the cap member 20 (FIG. 2). In this event, the porous membrane 30 is compressed to a predetermined thickness to such an extent that the resin J to be injected in the next process does not leak out. In other words, the length of the core pin 61 is adjusted to compress the porous membrane 30 to such an extent that the resin J to be injected in the next process does not leak out. The mold 60 for the barrel member 40 is equipped with a gate 63 for injection of the resin J, through which the resin J can be injected into the cavity 51.

Injection of Resin

As shown in FIG. 4A, molten resin J is injected through the gate 63 into the cavity 51 that is formed by the molds 50, 60 and the insert 10. In this instance, the peripheral edge of the porous membrane 30 is pressed by the injection pressure of the resin J that is charged in the cavity 51. In other words, the molten resin J is injected into the cavity 51 while applying an injection pressure to such an extent that the peripheral edge of the porous membrane 30 is compressed under a preferable pressure.

Mold-Opening and Taking Out Porous Membrane Cartridge 1

As shown in FIG. 4B, when the barrel member 40 is formed after injecting resin J into the cavity 51 and cooling and curing the resin J, the injection molding machine (not shown) is operated to open the mold and the porous membrane cartridge 1 is taken out. The peripheral edge 30a of the porous membrane 30 is sandwiched between the open edge portion 42b of the weld portion (barrel member-side weld portion) 42 that is formed by injection molding and the sandwiching surface 25 of the cap member 20, and retained while being compressed at the bottom portion 21 of the cap member 20. The inner peripheral surface 23a of the weld portion (cap member-side weld portion) 23 is molten by heat that is caused by the injection of high-temperature resin J, and as shown in FIGS. 5A and 5B, it becomes integral with the outer peripheral surface 42a of the weld portion 42.

In the above manufacturing method, it is preferable to form the barrel member 40 within one hour after molding the cap member 20, by inserting the cap member 20 (insert 10) within the cavity 51 followed by injection of resin J. More preferably, the barrel member 40 is formed within one minute after molding the cap member 20. When molding organic polymers, it is known that the molded product shrinks just after completing the molding process. Therefore, if the time required for inserting the cap member 20 into the cavity 51 after completing the molding process of the cap member 20 can be reduced, it is possible to increase the bond strength at the weld surface between the cap member 20 and the barrel member 40 in comparison with the case that the cap member 20 is inserted into the cavity 51 after a long period of time elapses after the molding process of the cap member 20 and the shrinkage of the cap member 20 is finished.

To be more specific, comparisons were made under the same manufacturing conditions using the same mold and the same molding machine. The bond strength at the weld surface of the manufactured porous membrane cartridge became 20% higher when the cap member 20 was inserted within one hour after molding the cap member 20 than when the cap member 20 was inserted after leaving it for one day after molding the cap member 20 and an occurrence of shrinkage of the cap member 20 is completed. Further, the bond strength increased for 50% when the cap member 20 was inserted within one minute after molding the cap member 20.

In order to set the cap member 20 in the cavity 51 within a short period of time after molding the cap member 20, it is preferable that two molding machines are arranged in an adjacent manner so that one molding machine is used for molding the cap member 20 while the other molding machine is used for molding the porous membrane cartridge 1 by inserting the cap member 20 that is just after molded. It may be possible to modify the mold, such as in the case of molding with a die slide, so as to allow the resin J to be inserted just after molding the cap member 20.

Manner of Use of Porous Membrane Cartridge

Manner of use of the porous membrane cartridge 1 will be described below with reference to FIG. 6.

Sample solution including nucleic acids is prepared. The sample solutions may be body fluid as a sample, such as whole blood to be collected, blood plasma, serum, urine, feces, semen and saliva, or solution prepared from a biological material, such as dissolution or homogenate of plant (including part of plant) or animal (including part of animal). These sample solution is processed by an aqueous solution including reagent for dissolving cell membranes and solubilizing nucleic acids. By this processing, cell membranes and nuclear membranes are dissolved, and nucleic acids disperse in the aqueous solution. For example, if the sample solution is whole blood, guanidine hydrochloride, Triton-X100, Protease K (SIGMA) are added to the sample solution, followed by incubation at 60° C. for 10 minutes to thereby remove red blood cells and various kinds of proteins and to dissolve white blood cells and nuclear membranes.

Water-soluble organic solvent such as ethanol is added to this resulting aqueous solution, into which nucleic acids disperse, to thereby provide a sample solution. This sample solution is introduced into the porous membrane cartridge 1 while applying pressure so that the sample solution flows from the opening 43a positioned at the rear end of the barrel member 40 to the discharge opening 22a positioned at the front end of the nozzle 22. Nucleic acids within the sample solution are then adsorbed by the porous membrane 30.

In the above pressurizing method where the sample solution is passed through the porous membrane while applying pressure, the sample solution is likely to flow aside toward the peripheral edge 30a of the porous membrane 30 when compared with centrifugal separation method where the sample solution is passed through the porous membrane by centrifugal force. However, since the peripheral edge 30a of the porous membrane 30 is compressed and retained between the open edge portion 42b of the barrel member-side weld portion 42 formed by injection molding and the sandwiching surface 25 of the cap member 20 as shown in FIG. 5A, the sample solution does not flow aside toward the side portion (edge portion of the outer periphery) of the porous membrane 30. Therefore, nucleic acids within the sample solution are adsorbed only at an inner region of the porous membrane 30 that is surrounded by the end portion of the barrel member-side weld portion 42.

Next, nucleic acid wash buffer solution is introduced into the porous membrane cartridge 1 while applying pressure so that the wash buffer solution flows from the opening 43a to the discharge opening 22a of the nozzle 22. The nucleic acid wash buffer solution has compositions not to desorb nucleic acids adsorbed by the porous membrane 30 but to desorb impurities. The nucleic acid wash buffer solution comprises base resin and buffering agent, and aqueous solution including surface-active agent as needed. Preferably, the base resin may be a solution including ethanol, Tris, and Triton-X100. This process allows impurities other than nucleic acids to be removed from the porous membrane 30.

The nucleic acid wash buffer solution flows through the porous membrane 30 and sufficiently to the region where the sample solution has flowed through, that is, the region surrounded by the end portion of the barrel member-side weld portion 42. Therefore, impurities can be removed without remaining at the peripheral edge 30a of the porous membrane 30.

Next, purified distilled water, TE buffer or the like is introduced from the opening 43a to the discharge opening 22a while applying pressure, so that nucleic acids are desorbed and flowed out from the porous membrane 30 and the solution including the nucleic acids thus flowed out is collected. As with the case of adsorbing nucleic acids to the porous membrane 30, purified distilled water or the like flows through the porous membrane 30 and sufficiently to the region surrounded by the end portion of the barrel member-side weld portion 42 and where nucleic acids are adsorbed. Therefore, impurities can be removed without remaining at the peripheral edge 30a of the porous membrane 30.

As described previously, when flowing the sample solution dispersing nucleic acids, the nucleic acid wash buffer solution or the purified distilled water into the porous membrane cartridge 1, the sample solution or the like does not flow aside toward the side portion of the porous membrane 30. Therefore, the collecting efficiency for nucleic acids can be enhanced because impurities do not enter the solution from which nucleic acids have been collected.

Further, when the porous membrane cartridge 1 is used for filtration, the liquid does not flow aside toward the side portion of the porous membrane 30. Therefore, few impurities are mixed into the liquid after filtration.

### EXAMPLE

Examples of the present invention will now be described below.

### Example 1

Porous membrane cartridges 1 as shown in FIGS. 1 and 6 were manufactured by insertion injection molding. Height (H) of the weld portion (cap member-side weld portion) 23 was set for 0, 0.5, 1, 2, 5, 7, 10 and 15 mm, respectively. With the use of a tensile tester, tensile force of 49N or 98N was applied to each of these porous membrane cartridges 1 between the barrel member 40 and the cap member 20, followed by introduction of testing liquid W from the opening 43a of the barrel member 40 to the discharge opening 22a of the nozzle 22 while applying pressure (1 kPa). Thereafter, examination was carried out to see whether the bond strength between the cap member-side weld portion 23 and the barrel member-side weld portion 42 was good or bad. The result was shown in Table 1.

In Table 1, “A” indicates the condition where the cap member 20 and the barrel member 40 were not come off by the applied tensile force so that the testing liquid W does not flow aside toward the side portion of the porous membrane 30, “B” indicates the condition where the testing liquid W seeps out at the side portion of the porous membrane 30 although the cap member 20 and the barrel member were not come off by the tensile force, and “C” indicates the condition where gaps appear at the weld surface between the cap member 20 and the barrel member 40 and they are come off by the applied tensile force.

The barrel member 40 and the cap member 20 were made of polystyrene (A&M Styrene Co., Ltd.). The barrel member 40 was formed so that the outer diameter of the weld portion 42 was 7 mm. The cap member 20 was formed so that the outer diameter (D) of the weld portion 23 was 8 mm, the maximum surface roughness at the inner peripheral surface 23a (FIG. 5A) was 10 μm, and no undercut shape was formed. Polypropylene porous membrane having 70 μm thickness (Mitsui-Sumitomo Corporation) was used as the porous membrane 30. Insertion molding (molding of the barrel member 40) was carried at one day after molding the cap member 20.

Considering the result as shown in Table 1, it is proved that if the ratio of the height (H) and the diameter (D) of the cap member-side weld portion 23, defined by H/D, is equal to or more than 0.07, a porous membrane cartridge 1 with better bond strength can be obtained.

TABLE 1

| Cap member-side weld portion | | | Tensile force | |
|---|---|---|---|---|
| Height H (mm) | OuterdiameterD (mm) | H/D | 49 (N) | 98 (N) |
| 0 | 8 | 0 | C | C |
| 0.5 | 8 | 0.06 | B | C |
| 1 | 8 | 0.13 | A | A |
| 2 | 8 | 0.25 | A | A |
| 5 | 8 | 0.63 | A | A |
| 7 | 8 | 0.88 | A | A |
| 10 | 8 | 1.25 | A | A |
| 15 | 8 | 1.88 | A | A |

### Example 2

Examination same as Example 1 to see whether the bond strength was good or bad was carried out. The result was shown in Table 2. The examination was substantially the same as Example 1 above except that the shape and the maximum surface roughness of the inner peripheral surface 23a of the cap member-side weld portion 23 were changed. Height of the cap member-side weld portion 23 and tensile force were set for 1 mm and 49 N, respectively. According to the result shown in Table 2, it is proved that if the cap member-side weld portion 23 has an undercut shape at its inner peripheral surface 23a or if the maximum surface roughness of the inner peripheral surface 23a becomes greater than 5 μm, a porous membrane cartridge 1 with better bond strength can be obtained.

TABLE 2
Inner peripheral surface of cap member-side weld portion

| Shape | Maximum surface roughness Rz (μm) | | |
|---|---|---|---|
| (Undercut) | 5 | 10 | 30 (surface texturing) |
| Without undercut | B | A | A |
| With undercut | A | A | A |

### Example 3

Examination same as Example 1 to see whether the bond strength was good or bad was carried out. The result was shown in Table 3. The examination was substantially the same as Example 1 above except that the insertion molding (molding of the barrel member 40) was carried out at one day, within one hour and within one minute after molding the cap member 20. Height of the cap member-side weld portion 23 was set for 0.5 mm, the inner peripheral surface 23a was formed not to have an undercut shape. According to the result shown in Table 3, it is proved that if the insertion molding (molding of the barrel member 40) is carried out within one hour after molding the cap member 20, a porous membrane cartridge 1 with better bond strength can be obtained.

TABLE 3

| Starting time for molding Barrel member | Tensile force (N) | | |
|---|---|---|---|
| (After molding Cap member) | 90 | 118 | 147 |
| One day | C | C | C |
| within one hour | A | A | C |
| within one minute | A | A | A |

While the present invention has been described with reference to preferred embodiments thereof, it is to be understood that various changed and modifications may be made without departing from the spirit of the invention.

What is claimed is:

1. A porous membrane cartridge comprising:
a tubular-shaped barrel member having a weld portion at an outer peripheral surface positioned adjacent to one end thereof;
a tubular-shaped cap member having a weld portion, inner peripheral surface of which contacts the weld portion of the barrel member, and a sandwiching surface which faces to an open edge portion of the weld portion of the barrel member; and
a porous membrane sandwiched between the open edge portion of the weld portion of the barrel member and the sandwiching surface of the cap member,
the porous membrane cartridge being manufactured by inserting the cap member and the porous membrane in a cavity of a mold for injection molding, and thereafter injecting molding material into the cavity to form the barrel member,
wherein the weld portion of the cap member has a ratio of its height (H) and its diameter (D), which is defined by H/D, to be equal to or greater than 0.07.

2. A porous membrane cartridge according to claim 1, wherein the weld portion of the cap member is formed such that a maximum surface roughness of the inner peripheral surface is greater than 5 μm.

3. A porous membrane cartridge according to claim 1, wherein the weld portion of the cap member has an undercut shape at the inner peripheral surface.

4. A porous membrane cartridge according to claim 1, wherein the porous membrane is a nucleic acid adsorptive porous membrane.

5. A porous membrane cartridge according to claim 2, wherein the porous membrane is a nucleic acid adsorptive porous membrane.

6. A porous membrane cartridge according to claim 3, wherein the porous membrane is a nucleic acid adsorptive porous membrane.

7. A porous membrane cartridge according to claim 1, wherein the barrel member is molded within one hour after molding the cap member.

8. A porous membrane cartridge according to claim 1, wherein the ratio H/D is equal to or smaller than 1.3.

9. A porous membrane cartridge according to claim 1, wherein the weld portion of the cap member is subject to surface texturing at the inner peripheral surface.

10. A porous membrane cartridge according to claim 1, wherein the weld portion of the cap member is subject to surface etching at the inner peripheral surface.

11. A porous membrane cartridge according to claim 4, wherein the porous membrane comprises a surface saponified material of acetyl cellulose.

12. A porous membrane cartridge according to claim 5, wherein the porous membrane comprises a surface saponified material of acetyl cellulose.

13. A porous membrane cartridge according to claim 6, wherein the porous membrane comprises a surface saponified material of acetyl cellulose.

14. A method of manufacturing a porous membrane cartridge comprising the steps of:
providing an injection mold having a cavity which corresponds to a tubular-shaped barrel member having a weld portion at an outer peripheral surface positioned adjacent to one end of the barrel member;
molding a tubular cap member having a weld portion and a sandwiching surface facing to an open edge portion of the weld portion of the barrel member, wherein the weld portion of the cap member contacts the weld portion of the barrel member at its inner peripheral surface and a ratio of its height (H) and its diameter (D), defined by H/D, is equal to or greater than 0.07;
positioning the cap member and the porous membrane within the cavity such that the weld portion of the cap member contacts the weld portion of the barrel member at the inner peripheral surface while positioning the sandwiching surface of the cap member in a manner facing to the open edge portion of the weld portion of the barrel member and setting the porous membrane with its peripheral edge abutting on the sandwiching surface of the cap member; and
injecting molding material into the cavity.

15. A method of manufacturing a porous membrane cartridge according to claim 14, wherein the molding material is injected within one hour after molding the cap member.

16. A method of manufacturing a porous membrane cartridge according to claim 14, wherein the step of molding the cap member includes providing the inner peripheral surface of the weld portion of the cap member with an undercut shape.

17. A method of manufacturing a porous membrane cartridge according to claim 14, wherein the step of molding the cap member includes applying a surface treatment to the weld portion of the cap member at the inner peripheral surface.

18. A method of manufacturing a porous membrane cartridge according to claim 14, wherein the step of molding the cap member includes processing the weld portion of the cap member such that a maximum surface roughness of the inner peripheral surface becomes greater than 5 μm.

19. A method of manufacturing a porous membrane cartridge according to claim 14, wherein the porous membrane is a nucleic acid adsorptive porous membrane.
